(19) United States
(12) Patent Application Publication
(10) Pub. No.: US 2004/0107686 A1
(43) Pub. Date: Jun. 10, 2004

(54) Method for espalier of olive trees and harvesting apparatus and method for espaliered trees

(76) Inventor: Antonio Isern, St. Helena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/704,500

(22) Filed: Nov. 6, 2003

Related U.S. Application Data
(60) Provisional application No. 60/425,189, filed on Nov. 7, 2002.

(51) Int. Cl. A01D 45/00

(52) U.S. Cl. 56/327.1

(57) ABSTRACT

Arraying the trees of an olive orchard in an espaliered disposition produces enhanced olive yield with efficient harvest. Olive trees are espaliered with confinement of the structurally supporting and nutrient supplying trunks and branches to a foot wide structural support plane centered on the espalier. Tree center to center spacing along the espalier is in the order of 9 feet with the espaliered rows having a 12 feet center to center spacing. The production planes are arrayed on either side of the espalier support plane for a distance of 2½ feet making the entire espalier including the central support plane and the two production planes a six foot wide array. The preferred height of the espaliered array is 12 feet with 12 foot spacing between rows. The two production planes are maintained with first year sprouts, second year fruit bearing branches, third year sprout bearing branches and trimmed clear of the fourth year branches.

### CROSS-REFERENCES TO RELATED APPLICATIONS

This invention claims priority from United States Provisional Patent Application Serial No. 60/425,189 filed Nov. 7, 2002 entitled Method for Espalier of Olive Trees and Harvesting Apparatus and Method for Espaliered Trees.

### STATEMENT AS TO RIGHTS TO INVENTIONS MADE UNDER FEDERALLY SPONSORED RESEARCH OR DEVELOPMENT

Not Applicable.

### REFERENCE TO A “SEQUENCE LISTING,” A TABLE, OR A COMPUTER PROGRAM LISTING APPENDIX SUBMITTED ON A COMPACT DISK.

Not Applicable.

This application relates to harvesting apparatus for olives, especially harvesting olives from espaliered olive trees arrayed into a trellis like disposition. Additionally, an espaliering process for olive trees know if the balance is disclosed, a harvesting apparatus for the espaliering olives in accordance with the espaliering process, and a process of harvesting utilizing the espaliered olive trees in combination with the harvesting device.

### BACKGROUND OF THE INVENTION

Olive orchards are notoriously old; they relate back to antiquity. In order that the reader may understand what follows, the cases of mature olive trees and then mature olive orchards are considered.

First, there are over 275 varieties of olives. In the usual case, olive trees mature over a span of about 15 years. At the end of this period of time, the crown of the tree forms a hemispherical shape having a diameter of 30 feet. The olive growing region or production zone of such a hemispherical crown is the outer 2½ foot portion of the hemisphere. Inward of this hemisphere, the tree comprises supporting and nutrient supplying branches. As will hereafter be emphasized, the mature tree has the disadvantage of having its production zone shade the interior portion of the olive tree. This renders useless for olive production the interior portion of the crown of the olive tree. This shading effect is not unlike that of a large umbrella; the portions of the tree shaded from sunlight cannot produce olives, the desired fruit of the tree.

In this production zone of the trees, successive sprouting and aging of the limbs of the living olive tree occurs. First year sprouts just grow; first year sprouts do not produce fruit. As these first year sprouts are the promise of future crops of the trees, it is important that they are not damaged during harvest.

Second year branches produce the fruit of the olive tree. By the third year, the branch is of larger diameter. This third year branch has its main utility in that first year sprouts emanate from it.

Finally, and in the fourth year, the branches become thick large branches. It is at this point that the branches serve only as structural and nutrient supplying members of the tree.

Regarding the mature olive orchard, approximately 100 trees per hectare is the normal density for mature trees. Harvest is rarely at the rate of 15 to 20 tons of olives per hectare. In order to accommodate the 30 feet diameter hemispherical crowns of mature trees, both trees and rows must be on a 30 feet spacing center to center spacing.

Automated olive harvesting has met with limited success. In what follows, I disclose an apparatus and process for the automated harvesting of olives, especially when the olives are arrayed in and espalier disposition.

### BRIEF SUMMARY OF THE INVENTION

Arraying the trees of an olive orchard in an espaliered disposition produces enhanced olive yield with efficient harvest. Olive trees are espaliered with confinement of the structurally supporting and nutrient supplying trunks and branches to a foot wide structural support plane centered on the espalier. Tree center to center spacing along the espalier is in the order of 9 feet with the espaliered rows having a 12 feet center to center spacing. The production planes are arrayed on either side of the espalier support plane for a distance of 2½ feet making the entire espalier including the central support plane and the two production planes a six foot wide array. The preferred height of the espaliered array is 12 feet with 12 foot spacing between rows. The two production planes are maintained with first year sprouts, second year fruit bearing branches, third year sprout bearing branches and trimmed clear of the fourth year branches.

The ratio of the production planes to the support planes of the olives trees is dramatically improved. Olive tree numbers in a typical olive orchard improve from 340 trees per hectare to 1000 trees per hectare and olive yield improving to 15 to 20 tons per hectare in a short period of maturation.

The harvest apparatus of this invention utilizes a rotating shaft having an array of tines. The shaft and rotating timings are confined within an olive capturing basket preferably having an olive capturing depression. The rotating tines have protruding resilient fingers, preferably made of rubber, which passes through the olives bearing branches dislodging the olives. Tine penetration occurs the full 2½ feet depth of the production plane of the olive tree being harvested.

In the tine passage through the production plane, no damage occurs to the first year spouts. Mature fruit (olives) are dislodged and fall to into the olive capturing basket from the second year branches. Finally, yielding of the third year branches occurs without damage to the first year sprouts or second year fruit producing branches. Further, the disclosed harvesting apparatus can be used with conventional olive orchards as well as the preferred espaliered disposition of this invention.

### BRIEF DESCRIPTION OF THE DRAWINGS

FIG. 1 is a plan view of a typical prior art olive orchard illustrating mature olive trees with their respective 2½ foot production zones shown in broken lines;

FIG. 2 is a plan view of a typical espaliered olive orchard in accordance with this invention with the production zones shown in broken lines;

FIG. 3A is a view of the harvesting apparatus having an array of rotating harvesting tines utilized to harvest the espaliered olive trees;

FIGS. 3B and 3C are views of the rotating shaft adjacent the joinder of the tines illustrating placement of cylindrical members parallel to the axis of the shaft for preventing entanglement of olive branches;

FIG. 3D is a detail taken at a tine illustrating the resilient fingers for harvesting olives in passage through the branches of the production zone of the olive tree;

FIG. 4A is a perspective view of an espaliered olive tree row prior to harvest; and,

FIG. 4B is the perspective view of the espaliered olive tree row having the rotating tines removing the mature olives.

### DETAILED DESCRIPTION OF THE INVENTION

Referring to FIG. 1, a portion of a mature prior art orchard is illustrated showing two adjacent mature olive trees T. Mature olive tree T includes a hemispherical 2½ foot production zone P peripheral to a large shaded central spherical volume S. This production zone P contains first-year sprouts, second-year olive producing branches, and still flexible third-year branches. Centrally of the tree there is the large shaded the central spherical volume S. This area is dominated by fourth year and older branches, which branches supply nutrients and structural support to the mature olive tree crown C. As is well-known in the olive industry, shaded central volume S does not produce olives. This volume which supplies nutrients and structural support is over abundant and largely wasted in so far as olive production is concerned.

The reader will understand that FIG. 1 illustrates a mature olive orchard. For a considerable period of time while an orchard grows, olive trees are of lesser size than the mature olive trees illustrated in FIG. 1. However, because the maturity of such trees must be anticipated, planting of the trees on the center to center spacing illustrated (approximately 30 feet between trees) must be made. Accordingly, as the olive orchard comes to maturity, considerable space is wasted within all of orchard.

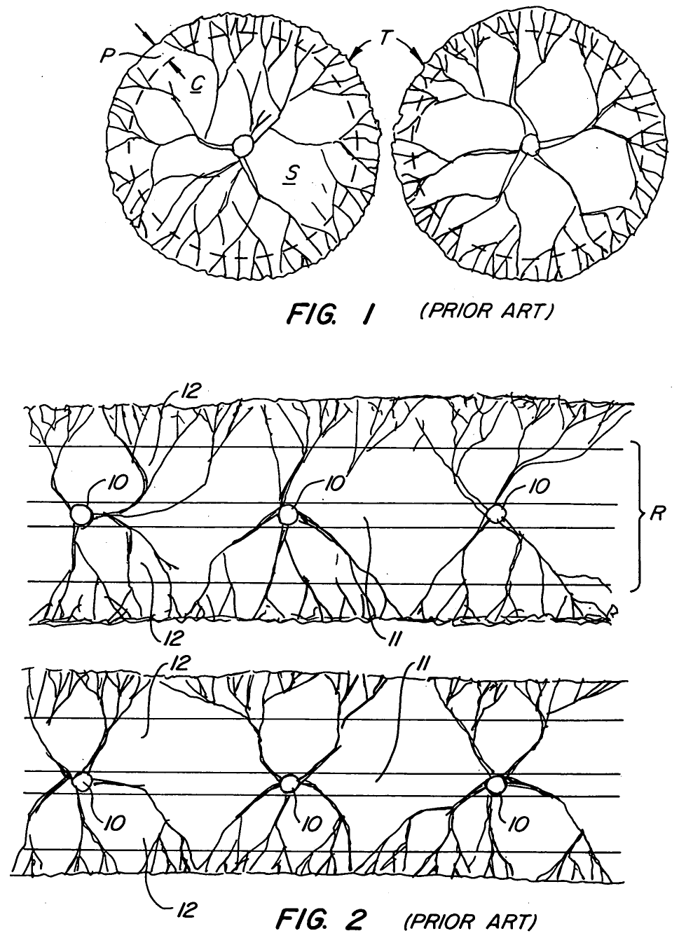

I propose the trellis disposition illustrated in FIG. 2. As this trellis disposition is described, the reader may compare shaded central spherical volume S of the mature orchard with the central support and nutrient zone 11 of the trellised orchard as illustrated in FIG. 2.

Referring to FIG. 2, individual trellis olive trees 10 are here illustrated planted on a 9 foot center to center basis in an elongated role R. Olive trees 10 during their growth have their central support and nutrient plants zone 11 confined to a narrow central volume here illustrated in the order of one foot of thickness. The reader will appreciate that dependent upon the variety of olive tree; nutrient plant zone 11 can be varied in thickness. While a relatively wider range of variation can be accommodated, in the normal case thickness would not exceed a 4 feet.

A further comment can be made about the trellis disposition of the olive orchard illustrated in FIG. 2. Specifically, as an olive orchard moves to maturity, the trellised orchard of FIG. 2 will utilize the production volume of the orchard much earlier as well as much more efficiently. As contrasted with the olive orchard in FIG. 1, the trellised orchard of FIG. 2 will mature to the disposition illustrated within a period of approximately five years. The mature olive orchard of FIG. 1 will not occupy the disposition shown in FIG. 1 until an interval of at least 10 years after planting.

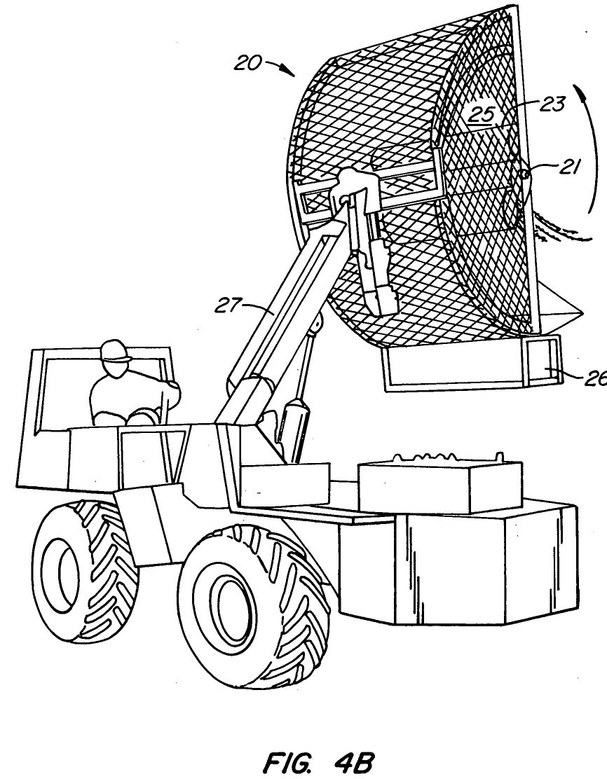

Exterior of central support and nutrient plant zone 11, a so-called production zone 12 is allowed to grow. This production zone includes first-year sprouts, second-year production branches, and still flexible third-year supporting and nutrient supplying branches. It is been found that when olives trees mature, harvest with the automated apparatus of his invention can easily occur with this branch array. It will further be understood that production zone 12 will extend above support and nutrient plant zone 11. In such an overhead volume, production zone 12 will in all probability be confined to the 2½ foot interval (dependant upon the species of olive tree being trellised). Such an overhead production volume is illustrated in broken lines in FIG. 4A.

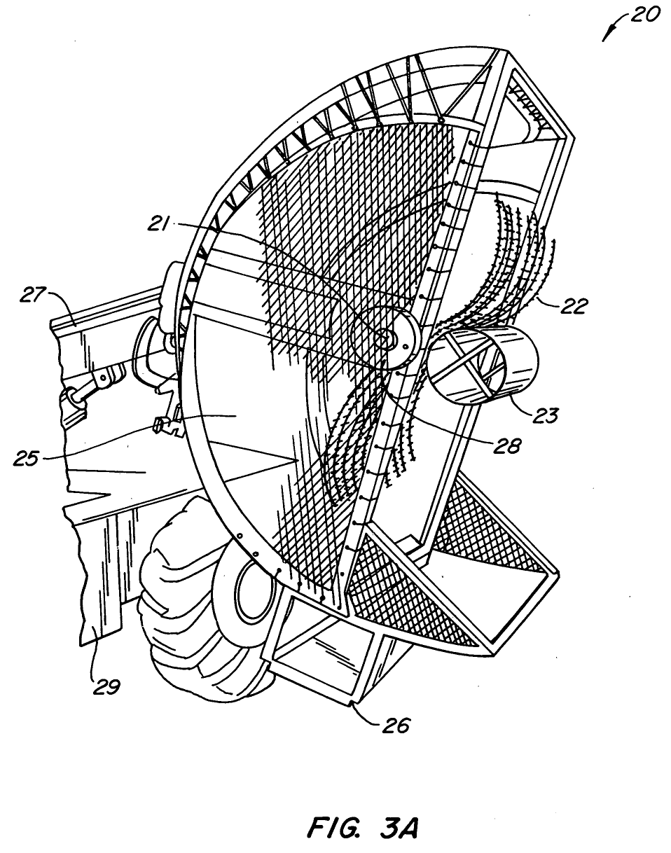

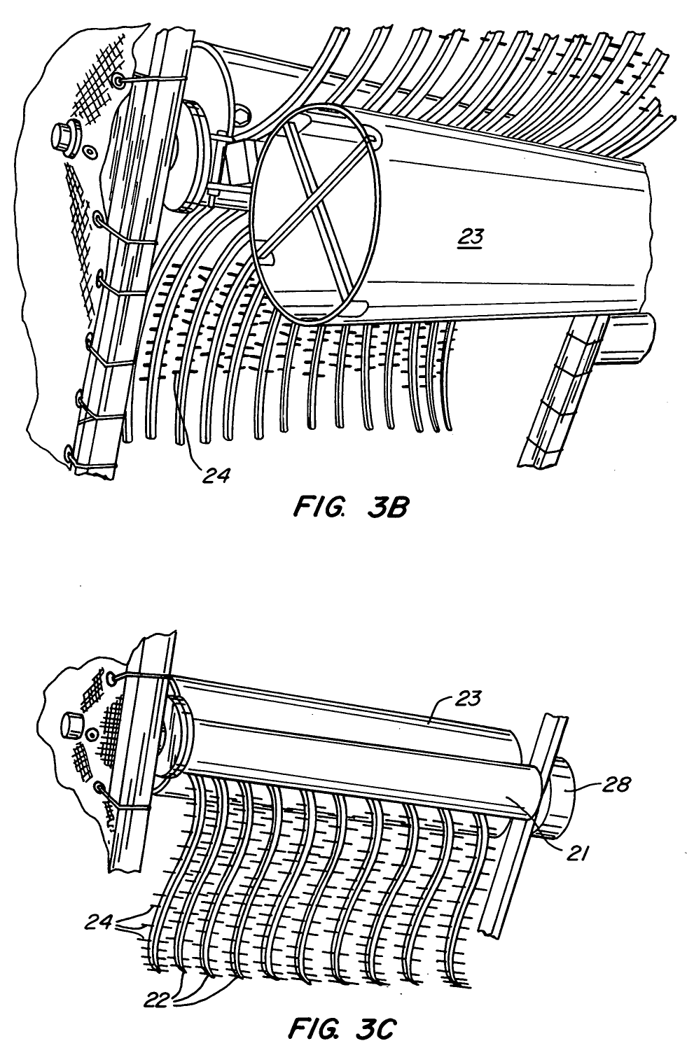

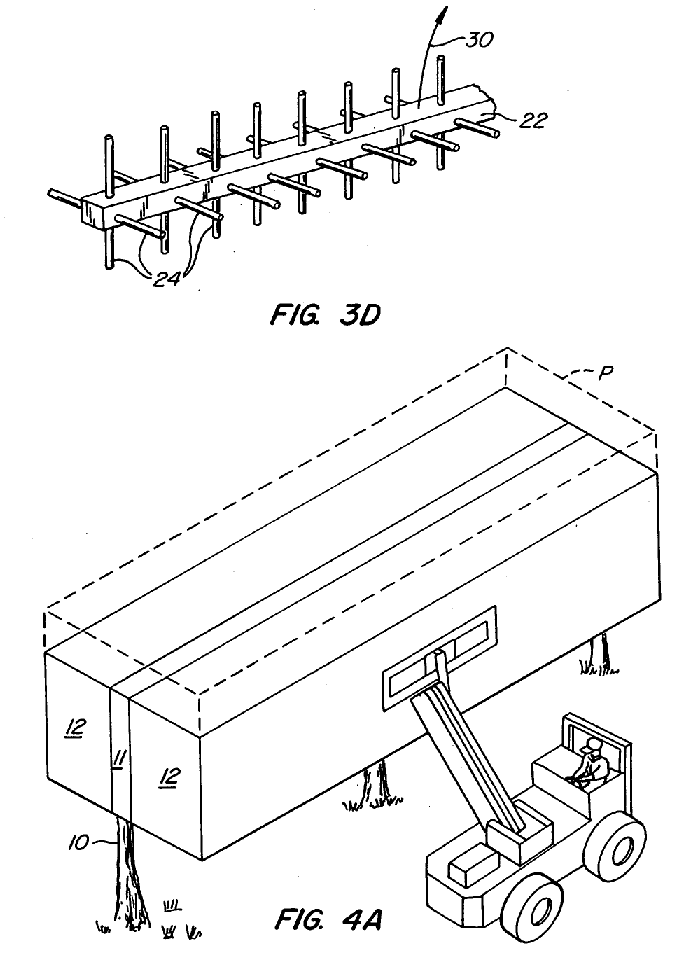

Referring to FIG. 3A, an olive harvesting apparatus 20 is illustrated. Support vehicle 29 having a universal arm 27 moves and orients harvesting apparatus 20 with respect to olive trees ready for harvest. This orientation of harvesting apparatus 20 is universal; the harvesting apparatus 20 can rotate from the horizontal disposition here illustrated to a vertical disposition. Further, angular inclination of the harvesting apparatus 20 can occur through many differing angularities. For example, when harvesting overlying production zone P such as that illustrated in broken lines in FIGS. 4A and 4B, it may be necessary to orient the harvesting apparatus so that the protruding rotating tines 22 are downwardly exposed from harvesting apparatus 20. It will be understood that universal arm 27 can telescope towards and away from the particular olive tree being harvested.

Harvesting apparatus 20 includes a powered rotating central shaft 21. Referring to FIGS. 3A and 3B, powered rotating central shaft 21 has a plurality of side-by-side shaft attached protruding tines 22. Tines 22 are given a separation dependent upon the type and species of olive tree being harvested. Here the illustrated separation between tines 22 at powered rotating central shaft 21 is on the order of six inches. Tines 22 are given a length is so that full penetration of production zone P occurs. In the case of most olive trees, this production zone will be in the order of 2½ feet. Accordingly, tines 22 are 2½ feet long as they protrude from powered rotating central shaft 21.

Tines 22 are arcuate. Generally, tines 22 arc toward the direction of their rotation. It is been found that this arcuate disposition gathers the olive branches within the production zone P and enables an efficient harvest.

Referring to FIG. 3C, a schematic illustrating shaft motor 28, powered rotating central shaft 21, and the some of the shaft attached protruding tines 22 is shown. In this schematic, protruding resilient fingers 24, typically made of rubber, are illustrated in their attachment to the respective sides of the tines 22. Referring to FIG. 3D, it will be understood that the protrusion of protruding resilient fingers 24 can be varied. In FIG. 3D, it will be seen that the resilient fingers 24 not only protrude from the sides of the shaft attached protruding tines 22 but additionally protrude in the direction of rotation and away from the direction of rotation of the tines, this direction of rotation being illustrated by the arrow 30.

It is been found, that if shaft attached protruding tines 22 are directly fastened to powered rotating central shaft 21, fouling of olive branches can occur at the junction between the tines 22 and the central shaft 21. To prevent such a fouling, anti-fouling cylinders 23 are placed interstitially of the attachment of the rows of shaft attached protruding tines 22.

As here illustrated, shaft attached protruding tines 22 are fastened to powered rotating central shaft 21 in discrete rows. There are two such rows here illustrated. Anti-fouling cylinders 23 are two in number and fastened at the interval between the rows of protruding tines 22. Further, anti-fouling cylinders 23 exceed by a factor of two the diameter of the powered rotating central shaft 21. With this particular disposition, it is been found that minimal fouling of branches in the production zone P occurs during harvest.

Referring back to FIG. 3A, powered rotating central shaft 21 with its shaft attached protruding tines 22 and anti-fouling cylinders 23 are surrounded by a tine surrounding basket 25. Tine surrounding basket 25 is here illustrated as half an ellipse in section. The elliptical section is truncated along its minor axis and oriented normally to the axis of powered rotating central shaft 21. The elliptical section generates a cylindrical basket section overlying the rotating tines. Further, tine surrounding basket 25 is closed at its respective ends. This basket 25 serves to collect harvested olives as they are dislodged at shaft attached protruding tines 22 by the protruding resilient fingers 25.

Finally, it is necessary to collect the harvested olives. Such collection typically occurs at an olive gathering basket protrusion 26. Preferably, olive gathering basket protrusion 26 is configured to the lowest portion of tine surrounding basket 25. Further, and as can be seen in FIG. 3A, powered rotating central shaft 21 rotates shaft attached protruding tines 22 in a counterclockwise direction. In this rotation, protruding tines 22 pass upwardly through the production zone P to which they are confronted. During this upward rotation, olives will be dislodged. As the rotation continues, the olives will be scooped into tine surrounding basket 25 at the upper portion of the tine surrounding basket. As the rotation continues, the olives will be swept into the interior surface of basket 25. As the olives continued to move into basket 25 they will gradually be classified to the exterior surface of basket 25. Thereafter, the olives will enter olive gathering basket protrusion 26. Accordingly, concentration of the harvested olives will occur within olive gathering basket protrusion 26.

Referring to FIGS. 4A and 4B, harvest of an orchard in the preferred trellis disposition illustrated in FIG. 2 is shown. In FIG. 4A, a row R shown in section. Individual trellis olive trees 10 are shown disposed in a trellis disposition. Central support and nutrient plant zone 11 supports production zones 12 on either side of support and nutrient zone 11. An overlying production zone 12′ is illustrated in broken lines. All of harvesting apparatus 20 is illustrated only at universal arm 27, powered rotating central shaft 21; shaft attached protruding tines 22, tine surrounding basket 25, and olive gathering basket protrusion 26.

Referring to FIG. 4B, harvest is illustrated with universal arm 27 confronting the olive harvesting apparatus 20 to row R. Viewing this harvest, it will be understood why the trellis disposition of the olive trees is especially preferred in the combination with the harvesting apparatus of his invention.

The reader will understand that the automated harvesting apparatus of his invention is not confined to use with trellis olive trees only. Harvesting can occur with respect to mature olive trees such as those illustrated in FIG. 1. It will be understood however, that the efficiency of the harvesting apparatus will be diminished in that the hemispherical shape of mature olive trees at their correspondingly hemispherical shaped production zone P will not realize the full efficiency of the apparatus.

Further, the dimension given herein are important in the usual case. Dependent upon the variety of olive encountered, these dimensions can be varied. However, growing on either side of said trellis first year sprouts, second and third year branches in production planes whereby the ratio of the production planes to the support plane is optimized is an important concept of my disclosure. Further, removing fourth year branches from the production planes to confine first, second and third year sprouts to the production planes necessarily describes the annual necessity of pruning to maintain my method of crop production.

What is claimed is:

1. A process of espaliering olive trees comprising the steps of:
providing a trellis;
arraying olive trees along the trellis;
confining nutrient supplying and tree supporting branches to a central support plane centered on the trellis;
growing on either side of said trellis first year sprouts, second and third year branches in production planes whereby the ratio of the production planes to the support plane is optimized; and
removing fourth year branches from the production planes to confine first, second and third year sprouts to the production planes.

2. The process of espaliering olive trees according to claim 1 comprising:
providing the trellis first and arraying the olive trees second.

3. The process of espaliering olive trees according to claim 1 comprising:
providing trellis second and the olive trees first.

4. The process of espaliering olive trees according to claim 3 comprising:
providing the trellis to an existing orchard.

5. A harvesting process for olive trees comprising the steps of:
providing a trellis;
arraying olive trees along the trellis;
confining nutrient supplying and supporting trunks and limbs to a support plane centered on the trellis;
growing on either side of said trellis first year sprouts, and second and third year branches in production planes whereby the ratio of the production plane to the support plane is optimized;
removing fourth year branches from the production planes;
ripening olive fruit in the production planes;
providing a plurality of side-by-side tines for passing through said production zones;
passing said side-by-side tines through the production zones to dislodge mature olives without damage to the first year sprouts and second and third year branches.

6. The harvesting process for olive trees in accordance with claim 5 comprising the steps of:
passing said side-by-side tines through the production zones includes passing the tines horizontally through the production zones.

7. The harvesting process for olive trees in accordance with claim 5 comprising the steps of:
passing said side-by-side tines through the production zone includes rotating the times about an axis.

8. The harvesting process for olive trees in accordance with claim 7 comprising the steps of:
passing said side-by-side tines through the production zone includes rotating the times about a vertical axis.

9. The harvesting process for olive trees in accordance with claim 8 comprising the steps of:
advancing the axis about which the tines rotate while rotating the tines about the vertical axis.

10. A harvesting apparatus for the production zone of olive trees comprising in combination:
rotatable shaft;
a plurality of tines attached to the routable shaft;
a plurality of resilient fingers attached to and protruding from each of the tines;
a basket partially surrounding the rotatable times with a portion of the rotatable tines protruding from the basket; and,
means for rotating the rotatable shaft whereby the tines at the resilient fingers pass through the production zone of an olive tree to dislodge for harvest olives on the tree.

11. The harvesting apparatus for the production zone of olive trees according to claim 10 comprising in combination:
mounting the rotating shaft and basket for changed orientation with respect to the production zone of the olive trees.

12. The harvesting apparatus for the production zone of olive trees according to claim 10 comprising in combination:
defining in the basket an olive capturing depression.

13. A harvesting process for olive trees in an orchard of espaliered olive trees wherein:
olive trees are arrayed along a trellis;
nutrient supplying and supporting trunks and limbs are confined to a support plane centered on the trellis;
first year sprouts, and second and third year branches are grown in production planes on either side of the support plane whereby the ratio of the production plane to the support plane is optimized;
fourth year branches are removed from the production planes; and,
ripening olive fruit is grown in the production planes;
the harvesting process comprising the steps of:
providing a plurality of side-by-side tines for passing through said production zones;
passing said side-by-side tines through the production zones to dislodge mature olives without damage to the first year sprouts and second and third year branches.

14. The harvesting process for olive trees in accordance with claim 13 comprising the steps of:
passing said side-by-side tines through the production zones includes passing the tines horizontally through the production zones.

15. The harvesting process for olive trees in accordance with claim 13 comprising the steps of:
passing said side-by-side tines through the production zone includes rotating the times about an axis.

16. The harvesting process for olive trees in accordance with claim 15 comprising the steps of:
passing said side-by-side tines through the production zone includes rotating the times about a vertical axis.

17. The harvesting process for olive trees in accordance with claim 16 comprising the steps of:
advancing the axis about which the tines rotate while rotating the tines about the vertical axis.
